(19) United States
(12) Patent Application Publication
(10) Pub. No.: US 2016/0102159 A1
(43) Pub. Date: Apr. 14, 2016

(54) Olefin Polymerization Catalyst and a Combined Catalyst Containing the Same

(71) Applicant: PETROCHINA COMPANY LIMITED, Beijing (CN)

(72) Inventors: Weisong Cui, Beijing (CN); Jianjun Yi, Beijing (CN); Baozuo Yin, Beijing (CN); Kejing Gao, Beijing (CN); Kefeng Wang, Beijing (CN); Kuilong Tan, Beijing (CN); Yonggang Wang, Beijing (CN); Jing Mao, Beijing (CN); Rongbo Li, Beijing (CN)

(21) Appl. No.: 14/879,554

(22) Filed: Oct. 9, 2015

(30) Foreign Application Priority Data
Oct. 10, 2014 (CN) 201410532338.1

(51) Int. Cl. C08F 110/06

(52) U.S. Cl. CPC C08F 110/06

(57) ABSTRACT

The present disclosure provides an olefin polymerization catalyst and a combined catalyst containing the same. The catalyst comprises a reaction product of a magnesium dialkoxide, a titanium compound, an electron donor compound A and an electron donor compound B, wherein the electron donor compound A is a sulfonyl compound represented by general formula I, X is a disubstituted or unsubstituted group 14 element atom, a monosubstituted or unsubstituted group 15 element atom or group 16 element atom, and the substituent is a monocyclic, polycyclic or heteroatom-containing cyclic group or an aliphatic chain; R₁ and R₂ are respectively hydrogen atom, halogen atom, substituted or unsubstituted alkyl, cycloalkyl, aryl, aralkyl, alkylaryl or heteroatom-containing cyclic group. The combined catalyst comprises the catalyst and an organoaluminium compound and can comprise an organosilicon compound. The catalyst has a high activity and a good stereospecificity, and polymers prepared therefrom have a good particle morphology and little fine powder.

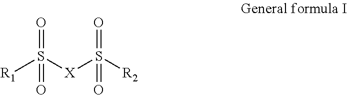

### TECHNICAL FIELD

The present disclosure relates to an olefin polymerization catalyst and a combined catalyst containing the same, which belongs to the technical field of olefin polymerization catalyst.

### BACKGROUND

With continuous improvement and innovation in the production process of olefin polymerization, higher requirements are proposed for the performance of olefin polymerization catalyst: better particle morphology, higher polymerization activity, better stereospecificity and better hydrogen sensitivity. The polyolefin catalyst prepared from magnesium dialkoxide has a high activity when catalyzing propylene polymerization, and the resultant polypropylene has advantages such as good particle morphology and high isotacticity. By adjusting the internal electron donor compound added during the synthesis of the catalyst, an object of adjusting the catalyst performance and the polymerization product performance may be achieved.

CN1653092A discloses a catalyst prepared by treating magnesium ethoxide with silicon tetrachloride followed by adding diether or diester-based internal electron donor compound, and then reacting with titanium tetrachloride. The catalyst prepared by the method, when catalyzing propylene polymerization as a component of a combined catalyst, has an acceptable catalyst activity, but has a low isotacticity of polymer and a high content of fine powder. CN1735632A discloses the use of a non-aromatic diester-based internal electron donor compound, and the attempt to use different types of external electron donor compounds; the catalyst activity is improved, but there remains the problem of low isotacticity of polymers and excessively high content of fine powders.

CN102603932A discloses a catalyst for olefin polymerization, which is prepared by adding dropwise a suspension, formed from a diester-based electron donor compound and a diether-based electron donor compound with magnesium ethoxide and toluene, into a solution of titanium tetrachloride in toluene in the synthesis process. The catalyst has a high polymerization activity, a high bulk density of polymer, and a low content of fine powders, but the stereospecificity seems normal.

### SUMMARY OF THE DISCLOSURE

To solve the above technical problem, an object of the present disclosure is to provide an olefin polymerization catalyst and a combined catalyst containing the same. The catalyst of the present disclosure has a high activity and a good stereospecificity, and the produced polymer has a good particle morphology and little fine powder.

In some embodiments, the present disclosure provides an olefin polymerization catalyst comprising a reaction product of the following raw materials: a magnesium dialkoxide, a titanium compound, an electron donor compound A and an electron donor compound B;

wherein the electron donor compound A is a sulfonyl compound represented by general formula I:

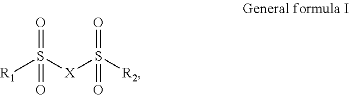

wherein X can be selected from a group consisting of a disubstituted or unsubstituted group 14 element atom, a monosubstituted or unsubstituted group 15 element atom, and group 16 element atom, where the substituent of the disubstituted group 14 element atom and the monosubstituted group 15 element atom is selected from a group consisting of a monocyclic, polycyclic or heteroatom-containing cyclic group and an aliphatic chain group; R₁ and R₂ are the same or different, and are respectively selected from a group consisting of hydrogen atom, halogen atom, substituted or unsubstituted alkyl, cycloalkyl, aryl, aralkyl, alkylaryl and heteroatom-containing cyclic group;

the electron donor compound B can be selected from a group consisting of an ester compound and an ether compound;

the titanium compound can have a general formula of Ti(OQ)₄₋ₙYₙ, where Q is selected from a group consisting of C₁-C₁₄ aliphatic hydrocarbyl and aromatic hydrocarbyl, Y is halogen atom, n is an integer of 0 to 4; when n is 2 or less, Qs are the same or different;

the electron donor compound A can be used in an amount of 0.01 to 1 mole with respect to 1 mole of magnesium in the magnesium dialkoxide; such as in an amount of 0.05 to 0.2 mole with respect to 1 mole of magnesium in the magnesium dialkoxide

the electron donor compound B can be used in an amount of 0.01 to 1 mole with respect to 1 mole of magnesium in the magnesium dialkoxide; such as in an amount of 0.05 to 0.2 mole with respect to 1 mole of magnesium in the magnesium dialkoxide; and

the titanium compound can be used in an amount of 0.5 to 100 mole(s) with respect to 1 mole of magnesium in the magnesium dialkoxide; such as in an amount of 1 to 50 mole(s) with respect to 1 mole of magnesium in the magnesium dialkoxide.

In the olefin polymerization catalyst, X can be selected from a group consisting of C(R₃)(R₄), Si(R₃′)(R₄′), Sn(R₃″)(R₄″), Pb(R₃′″)(R₄′″), N(R₅), P(R₆), As(R₆′), O, S, Se and Te; wherein R₃ and R₄ are the same or different, R₃′ and R₄′ are the same or different, R₃″ and R₄″ are the same or different, R₃′″ and R₄′″ are the same or different, R₃, R₄, R₃′, R₄′, R₃″, R₄″, R₃′″, R₄′″, R₅, R₆ and R₆′ are respectively selected from a group consisting of hydrogen atom, halogen atom, substituted or unsubstituted alkyl, cycloalkyl, aryl, aralkyl, alkylaryl, alkylalkenyl, alkenylalkyl, alkylalkynyl, heteroatom-containing cyclic group and acyl. Among others, R₃, and R₄ can also form cycloalkyl or cycloalkenyl with carbon atom.

In the olefin polymerization catalyst, the electron donor compound A can be selected from a group consisting of disulfonyl alkane, disulfonyl olefin, disulfonyl cyclic hydrocarbon, disulfonyl silane, disulfonyl cyclosilane, disulfonyl dihydrocarbyl tin, disulfonyl dihydrocarbyl lead, and derivatives thereof with or without heteroatom; disulfonyl imine, disulfonyl phosphorous, disulfonyl arsenous, and derivatives thereof with or without heteroatom; substituted or unsubstituted sulfonic anhydride, and S-substituted or Se-substituted derivatives thereof.

In the olefin polymerization catalyst, the electron donor compound A may be selected from a group consisting of bis(trifluoromethylsulfonyl)-methane; [bis(trifluoromethylsulfonyl)methyl]-benzene; 1,1-bis(trifluoromethylsulfonyl)-ethane; [chloro-(trifluoromethylsulfonyl)-methylsulf onyl]-trifluoro-methane; [bromo-(trifluoromethylsulfonyl)-methylsulfonyl]-trifluoro-methane; dichloro-bis-trifluoromethylsulfonyl-methane; dibromo-bis-trifluoromethylsulfonyl-methane; chloro-bromo-bis-trifluoromethylsulfonyl-methane; 2-[2,2-bis-(trifluoromethylsulfon yl)-vinyl]-1H-pyrrole; 4-[2,2-bis-(trifluoromethylsulfonyl)vinyl]-morpholine; 2-[2,2-bis-(trifluoromethylsulfonyl)-vinyl]-1H-indole; trifluoro-[methoxy-(trifluoromethylsulfonyl)-methylsulfonyl]-methane; 1-chloro-1,1-bis(trifluoromethylsulfonyl)-ethane; 1-bromo-1,1-bis(trifluoromethylsulfonyl)-ethane; 4,4-bis-(trifluoromethylsulfonyl)-but-1-ene; 1,3-bis-(trifluoromethylsulfonyl)-propan-1-ol; 1,1-bis-(trifluoromethylsulfonyl)-pentane; 4-bromo-4,4-bis-(trifluoromethylsulfonyl)-but-1-ene; 3-bromo-5-chloro-1,1-bis-(trifluoromethylsulfonyl)-pentane; 3-brom o-1,1-bis-(trifluoromethylsulfonyl)-nonane; [2,2-bis-(trifluoromethylsulfonyl)-ethyl]-benzene; 3-bromo-5,5-bis-(trifluoromethylsulfonyl)-pentanoic acid; 1,1-bis-(trifluoromethylsulfonyl)-propene; 2,2-bis-(trifluoromethylsulfonyl)-vin ylamine; [2,2-bis-(trifluoromethylsulfonyl)-vinyl]-dimethyl-amine; [3,3-bis-(trifluoro methylsulfonyl)-allyl]-benzene; 1-[2,2-bis-(trifluoromethylsulfonyl)-vinyl]-naphthalene; 4-[2,2-bis-(trifluoromethylylsulfonyl)-vinyl]-2-ethoxy-phenol; 1-[2,2-bis-(trifluoromethylsulfonyl)-vinyl]-4-nitro-benzene; (2,2-bis-trifluoromethanesulfonyl-vinyl)-benzene; 7,7-bis-(trifluoromethylsulfonyl)-bicyclo[4,1,0]-heptane; 1-[bis-(trifluoromethylsulfonyl)-methyl]-4-methyl-benzene; bis-(trifluoromethylsulfonyl)-ethenone; 1-[bis-(trifluoromethylsulfonyl)-methylene]-pyrimidine; [bis-(trifluoromethylsulfonyl)-methylene]-triphenyl-λ5-phosphorus; 1-[bis-(trifluoromethylsulfonyl)-m ethyl]-4-fluoro-benzene; difluoro-bis-trifluoromethylsulfonyl-methane; ethyl 3,2-bis-trifluoromethylsulfonyl-cyclopropane carboxylate; trifluoro-(fluoro-trifluoromethylsulfonyl-sulfonylmethyl)-methane; 1-(bis-trifluoromethylsulfonyl-methyl)-2,3,4,5,6-pentafluorobenzene; {4-[2,2-bis-(trifluoromethylsulfon yl)-vinyl]-phenyl}-diethyl-amine; {4-[4,4-bis-(trifluoromethylsulfonyl)-butyl-1,3-diethyl]-phenyl}-dimethyl-amine; 2-[2,2-bis-(trifluoromethylsulfonyl)-ethyl]-malonic acid; ethyl 2-[2,2-bis-(trifluoromethylsulfonyl)-ethyl]-3-oxo-butyrate; diethyl 2-[2,2-bis-(trifluoromethylsulfonyl)-ethyl]-2-bromo-malonate; 1,1,3,3-tetrakis-(trifluoromethylsulfonyl)-propane; 1,1,2,2-tetrakis-(trifluoromethylsulfonyl)-ethane; trifluoro-[methoxy-(trifluoromethylsulfonyl)-methanesulfonyl]-methane; [bis-(trifluoromethylsulfonyl)-methanesulfonyl]-trifluoro-methane; bis-(trifluoromethylsulfonyl)-ethenone; ethyl 1,2-di-(trifluoromethylsulfonyl)-malonate; [(dimethyl-λ4-sulfonamidenyl)-trifluoromethylsulfonyl-mesyl]-trifluoro-methane; 1-diethyl-sulfonamide-2,2-bis(trifluoromethylsulfonyl)-ethylene; 1-[bis-(trifluoromethylsulfonyl)-methyl]-4-iodo-benzene; 1-[bis-(tri fluoromethylsulfonyl)-methyl]-4-fluoro-benzene; N-[bis-(trifluoromethylsulfonyl)-methylene]-N′-(4-nitro-phenyl)-hydrazine; 2,2-bis(isopropylamine)-1,1-(trifluoromethylsulfonyl)-ethylene; 1-(2,2-bis-trifluoromethylsulfonyl-cyclopropyl)-ethanone; 1-(2,2-trifluoromethanesulfonyl-vinyl)-4-methyl-benzene; dimethyl(1-p-tolyl-2,2-bis-trifluoromethanesulfonyl-ethyl)-phosphate; 1-(bis-trifluoromethylsulfonyl-methylsulfonyl)-4-chloro-benzene; (1-methyl-2,2-bis-trifluoromethyl sulfonyl-vinyl)-phenyl-amine; 1-(bis-trifluoromethylsulfonyl-methyl)-4-tetra-butyl-2,3,5,6-tetrafluoro-benzene; 1-(bis-trifluoromethylsulfonyl-methyl)-4-tetra-butyl-2,3,5,6-tetrafluoro-biphenyl; trimethyl-(pentafluorophenyl-bis-trifluoromethyl-sulfonyl-methyl)-silane; fluoro-tris-trifluoromethylsulfonyl-methane; 1-(bis-trifluoromethylsulfonyl-methyl)-2,3,5,6-tetrafluoro-4-hexyloxy-benzene; N-phenyl-bis(trifluoromethylsulfonyl)amine; N-2,6-diisopropylphenyl-bis(trifluoromethylsulfonyl)amine; N-(4-methoxyphenyl)-bis(trifluoromethylsulfonyl)amine; N-(3-chlorophenyl)-bis(trifluoromethylsulfonyl)amine; N-(2-fluorophenyl)-bis(trifluoromethylsulfonyl)amine; N-isobutyl-bis(trifluoromethylsulfonyl)amine; N-(2-methoxyethyl)-bis(trifluoromethylsulfonyl)amine; N-ethyl-bis(trifluoromethylsulfonyl)amine; N-benzyl-bis(trifluoromethylsulfonyl)amine; N-n-hexyl-bis(trifluoromethylsulfonyl)amine; N-(2-phenylethyl)-bis(trifluoromethylsulfonyl)amine; N-thienyl-bis(trifluoromethylsulfonyl)amine; N-cyclohexyl-bis(trifluoromethylsulfonyl)amine; N-(4-fluorophenyl)-bis(trifluoromethylsulfonyl)amine; N-(3-methylphenyl)-bis(trifluoromethylsulfonyl)amine; N-(4-methylphenyl)-bis(trifluoromethylsulfonyl)amine; N-(4-carboxyphenyl)-bis(trifluoromethylsulfonyl)amine; N-(3-carboxyphenyl)-bis(trifluoromethylsulfonyl)amine; bis(trifluoromethylsulfonyl)amine; N-fluoro-bis(trifluoromethylsulfonyl)amine; N-(2-pyridinyl)-bis(tri fluoromethylsulfonyl)amine; N-(5-chloro-2-pyridinyl)-bis(trifluoromethylsulfonyl)amine; N-(trimethylsilyl)-bis(trifluoromethylsulfonyl)amine; N-isopropyl-bis(tri fluoromethylsulfonyl)amine; phosphine-phenyl-bis(trifluoromethylsulfonyl)phosphorous; trifluoromethanesulfonic anhydride.

In the olefin polymerization catalyst, the sulfonyl compound represented by the general formula I may be used alone or in combination; when used in combination, the compounds may be mixed in any ratio.

In the olefin polymerization catalyst, the electron donor compound B can be selected from a group consisting of a carboxylic acid ester compound and a diether compound.

In the olefin polymerization catalyst, the carboxylic acid ester compound includes monovalent or polyvalent aliphatic carboxylic acid ester and aromatic carboxylic acid ester. In some embodiments, the carboxylic acid ester compound includes benzoates, phthalates, malonates, succinates, glutarates, pivalates, carbonates and the like. In some examples, it may include ethyl benzoate, diethyl phthalate, di-n-butyl phthalate, diisobutyl phthalate, di-n-octyl phthalate, diisooctyl phthalate, diethyl malonate, dibutyl malonate, diethyl 2,3-diisopropylsuccinate, di-n-butyl 2,3-diisopropylsuccinate, diisobutyl 2,3-diisopropylsuccinate, dimethyl 2,3-diisopropylsuccinate, diisobutyl 2,2-dimethylsuccinate, diisobutyl 2-ethyl-2-methylsuccinate, diethyl 2-ethyl-2-methyl succinate, diethyl adipate, dibutyl adipate, diethyl sebacate, dibutyl sebacate, diethyl maleate, di-n-butyl maleate, diethyl naphthalenedicarboxylate, dibutyl naphthalenedicarboxylate, triethyl trimellitate, tributyl trimellitate, tributyl hemimellitate, triethyl hemimellitate, tetraethyl pyromellitate and tetrabutyl pyromellitate.

In the olefin polymerization catalyst, the carboxylic acid ester compound may be used alone or in combination; when used in combination, the compounds can be mixed in any ratio.

In the olefin polymerization catalyst, the diether compound can include 1,3-diether compound. In some embodiments, the diether compound includes 1,3-diether compounds disclosed in CN1042547 A and CN1041752A. Both of the patent application publications are incorporated herein by reference in their entirety.

In the olefin polymerization catalyst, the diether compound may be used alone or in combination; when used in combination, the compounds can be mixed in any ratio.

In the olefin polymerization catalyst, the magnesium dialkoxide can be selected from a group consisting of magnesium dimethoxide, magnesium diethoxide, magnesium dipropoxide, magnesium dibutoxide, magnesium dihexyloxide, magnesium dioctyloxide, magnesium diphenoxide, magnesium dicyclohexyloxide and the like. The magnesium dialkoxide may be used alone or in combination; when used in combination, the magnesium dialkoxides can be mixed in any ratio. In some embodiments, the magnesium dialkoxide is magnesium diethoxide.

In certain embodiments of the present disclosure, the olefin polymerization catalyst can be produced by using the magnesium dialkoxide as a support and an inert solvent as a dispersant, contacting with the titanium compound, then contacting with the electron donor compound A and the electron donor compound B, and contacting again with the titanium compound.

In the olefin polymerization catalyst, the inert solvent can be selected from a group consisting of hexane, heptane, octane, decane, benzene, toluene and xylene, and is used in an amount of 0.5 to 100 mole(s) with respect to 1 mole of magnesium in the magnesium dialkoxide. In some embodiments, it is used in an amount of 1 to 50 mole(s) with respect to 1 mole of magnesium in the magnesium dialkoxide. The inert solvent can be used alone or in combination; when used in combination, the solvents can be mixed in any ratio.

In the production of the olefin polymerization catalyst of the present disclosure, the raw materials can be contacted at a temperature of −50 to 180° C., for example −20 to 150° C., for a contact time of 5 minutes to 10 hours, for example 10 minutes to 5 hours. The order of the raw materials to be contacted is not particularly limited, for example, the raw materials can be contacted in the presence (dilution) of the inert solvent, or can be diluted with the inert solvent in advance before contacting them. The number of contact is not particularly limited, and the contact may be carried out once, or may be carried out several times, as long as the relationship between the total amount of each raw material could meet the above limitations of the present disclosure. The solid catalyst obtained by the above contact reaction may be washed with the inert solvent, for example, one or a mixture of hexane, heptane, octane, decane, benzene, toluene, and xylene. In some examples, toluene and/or hexane can be used for washing. The amount of the inert solvent used for washing, and the time and number of washing are not particularly limited, and may be conventionally regulated by one skilled in the art. Drying may be carried out after washing, and the drying temperature and time are conventional in the art.

In some embodiments of the present disclosure, the olefin polymerization catalyst is produced by the following method:

mixing the magnesium dialkoxide with the inert solvent to give a suspension, adding the titanium compound (such as titanium tetrachloride) to the suspension, subsequently adding thereto the electron donor compound A to contact for a period of time, separating the liquid from the solid, contacting the separated solid with the titanium compound and the electron donor compound B in the presence of the inert solvent for a period of time, separating again the liquid from the solid, washing the solid with the inert solvent, then contacting the solid with the titanium compound again for a period of time, and finally washing the solid with the inert solvent and drying the solid, to give the olefin polymerization catalyst.

The olefin polymerization catalyst of the present disclosure can be produced by using the magnesium dialkoxide as a support, reacting with the titanium compound in the inert solvent as a dispersant, then contacting with the sulfonyl compound as an internal electron donor, and at least one carboxylic acid ester and/or diether compound, followed by treatment with the titanium compound. The catalyst has an excellent overall performance when used for catalyzing the olefin polymerization, especially propylene polymerization.

The present disclosure also provides a combined catalyst for olefin polymerization comprising the following components:

component (1): the olefin polymerization catalyst described herein;

component (2): an organoaluminum compound having a general formula of AlTₘZ₃₋ₘ, where T is selected from a group consisting of hydrogen, and C₁-C₂₀ hydrocarbyl, Z is halogen atom, and m is an integer of no greater than 3;

wherein the ratio of the component (1) to the component (2) is 10 to 1000, for example 20 to 500 in terms of the molar ratio of aluminum to titanium.

In some embodiments of the present disclosure, the combined catalyst for olefin polymerization further comprises component (3): an organosilicon compound having a general formula of L₁L₂Si(OL′)₂, where L₁ and L₂ are the same or different, and are respectively selected from a group consisting of C₁-C₂₀ alkyl, C₃-C₂₀ cycloalkyl and C₃-C₂₀ aryl, L′ is C₁-C₄ alkyl; wherein the ratio of the component (2) to the component (3) is 4 to 40 in terms of the molar ratio of aluminum to silicon.

The three components may be stored separately, and then added together upon the olefin polymerization reaction for catalyzing polymerization reaction.

In the combined catalyst, the organoaluminum compound can be selected from a group consisting of trimethylaluminum, triethylaluminum, trioctylaluminum, and alkyl aluminum halides such as diethyl aluminum chloride, diisobutyl aluminum chloride, and ethyl aluminum dichloride. In some examples, the organoaluminum compound can be triethylaluminum. The organoaluminium compound may be used alone or in combination; when used in combination, the compounds can be mixed in any ratio.

In the combined catalyst, the organosilicon compound can be selected from a group consisting of trimethyl methoxy silane, trimethyl ethoxy silane, trimethyl phenoxy silane, dimethyl dimethoxy silane, dimethyl diethoxy silane, methyl cyclohexyl dimethoxy silane, methyl cyclohexyl diethoxy silane, diphenyl dimethoxy silane, diphenyl diethoxy silane, phenyl trimethoxy silane, phenyl triethoxy silane and vinyl trimethoxy silane. The organosilicon compound may be used alone or in combination; when used in combination, the compounds can be mixed in any ratio.

The olefin polymerization catalyst and the combined catalyst provided by the present disclosure, when catalyzing the olefin polymerization, such as propylene polymerization, have a high activity, a good stereospecificity, and an excellent overall performance, and obtain a polymer with a good particle morphology and little fine powder, which is suitable for development of polyolefin grades.

### DETAILED DESCRIPTION

In order to have a more clear understanding of the technical features, objects and advantageous effect of the present disclosure, the technical solutions of the present disclosure will be described in detail below, but it cannot be understood as a limitation of the implementable scope of the present disclosure.

Evaluation Method:

(1) The activity of the catalyst is calculated by dividing the mass of the polymerization product by the mass of the catalyst;

(2) the titanium content in the catalyst is determined using ICP/AES;

(3) the isotacticity index (II) of polymer is determined by extraction method with boiling n-heptane;

(4) the melt flow rate (MFR) of polymer is determined according to the standard GB/T3682-2000;

(5) the bulk density (BD) of polymer is determined by a method of the weight of bulk solid in unit volume.

### Example 1

This example provided an olefin polymerization catalyst prepared by the following method:

in a 300 mL reaction vessel with repeated substitution by high purity nitrogen, 10 g of magnesium diethoxide (d(0.5): 32 μm, SPAN value: 0.9) and 80 mL of toluene were charged to prepare a suspension, and cooled to 0° C.; 20 mL of titanium tetrachloride was added to the suspension, and then gradually warmed to 80° C.; 0.01 mol of an internal electron donor, N-m-chlorophenyl-bis(trifluoromethylsulfonyl)amine was added, reacted at the temperature for half an hour, and then reacted for 2 hours when the reaction temperature was raised to 110° C.; the liquid was removed by filtration under pressure, then 80 mL of toluene, 20 mL of titanium tetrachloride and 0.01 mol of an internal electron donor, di-n-butyl phthalate were added, and reacted at 110° C. for 2 hours; the liquid was removed by filtration under pressure, and the solid was washed three times with 100 mL of toluene at 80° C., and then treated with 20% (v/v) toluene solution of titanium tetrachloride at 110° C. for 1 hour; finally, the solid was washed three times with 100 mL of toluene at 80° C., and five times with 100 mL of hexane at 40° C. in order, and the resultant solid product was dried to obtain the olefin polymerization catalyst of this Example.

### Example 2

This Example provided an olefin polymerization catalyst prepared by a method substantially the same as that of Example 1, except only that the amount of the internal electron donor, N-m-chlorophenyl-bis(trifluoromethylsulfonyl)amine to be added was changed to 0.015 mol.

### Example 3

This Example provided an olefin polymerization catalyst prepared by a method substantially the same as that of Example 1, except only that the amount of the internal electron donor, N-m-chlorophenyl-bis(trifluoromethylsulfonyl)amine to be added was changed to 0.005 mol.

### Example 4

This Example provided an olefin polymerization catalyst prepared by a method substantially the same as that of Example 1, except only that the internal electron donor, di-n-butyl phthalate was changed to diisobutyl phthalate with the same additional amount.

### Example 5

This Example provided an olefin polymerization catalyst prepared by a method substantially the same as that of Example 1, except only that the internal electron donor, di-n-butyl phthalate was changed to 2,2-diisopropyl-1,3-dimethoxypropane with the same additional amount.

### Example 6

This Example provided an olefin polymerization catalyst prepared by a method substantially the same as that of Example 1, except only that the internal electron donor, N-m-chlorophenyl-bis(trifluoromethylsulfonyl)amine was changed to N-phenyl-bis(trifluoromethylsulfonyl)amine with the same additional amount.

### Example 7

This Example provided an olefin polymerization catalyst prepared by a method substantially the same as that of Example 1, except only that the internal electron donor, N-m-chlorophenyl-bis(trifluoromethylsulfonyl)amine was changed to N-methoxyphenyl-bis(trifluoromethylsulfonyl)amine with the same additional amount.

### Example 8

This Example provided an olefin polymerization catalyst prepared by a method substantially the same as that of Example 1, except only that the internal electron donor, N-m-chlorophenyl-bis(trifluoromethylsulfonyl)amine was changed to N-ethyl-bis(trifluoromethylsulfonyl)amine with the same additional amount.

### Example 9

This Example provided an olefin polymerization catalyst prepared by a method substantially the same as that of Example 1, except only that the internal electron donor, N-m-chlorophenyl-bis(trifluoromethylsulfonyl)amine was changed to N-n-hexyl-bis(trifluoromethylsulfonyl)amine with the same additional amount.

### Comparative Example 1

This Comparative Example provided an olefin polymerization catalyst prepared by the following method:

in a 300 mL reaction vessel with repeated substitution by high purity nitrogen, 10 g of magnesium diethoxide (d(0.5): 32 μm, SPAN value: 0.9) and 80 mL of toluene were charged to prepare a suspension, and cooled to 0° C.; 20 mL of titanium tetrachloride was added to the suspension, and then gradually warmed to 80° C.; 0.01 mol of an internal electron donor, di-n-butyl phthalate were added, and reacted for 2 hours when warmed to 110° C.; the liquid was removed by filtration under pressure, and the solid was washed three times with 100 mL of toluene at 80° C., and then treated with 20% (v/v) toluene solution of titanium tetrachloride at 110° C. for 1 hour; finally, the solid was washed three times with 100 mL of toluene at 80° C., and five times with 100 mL of hexane at 40° C. in order, and the resultant solid product was dried to obtain the olefin polymerization catalyst of this Comparative Example.

### Comparative Example 2

This Comparative Example provided an olefin polymerization catalyst prepared by a method substantially the same as that of Comparative Example 1, except only that the internal electron donor, di-n-butyl phthalate was changed to diisobutyl phthalate with the same additional amount.

### Comparative Example 3

This Comparative Example provided an olefin polymerization catalyst prepared by a method substantially the same as that of Comparative Example 1, except only that the internal electron donor, di-n-butyl phthalate was changed to 2,2-diisopropyl-1,3-dimethoxypropane with the same additional amount.

Olefin Polymerization

In a 5 L stainless steel autoclave equipped with a stirrer, and substituted with nitrogen, 10 mL of a solution of triethylaluminum in hexane (triethylaluminum concentration: 2.4 mol/L), 6 mL of a solution of cyclohexylmethyldimethoxy silane (CHMMS) in hexane (CHMMS concentration: 0.18 mol/L), and 20 mg of the olefin polymerization catalyst prepared in the Example or the Comparative Example were added; the autoclave was closed, and 4.5 L of hydrogen (standard state) and 2 L of liquid propylene were introduced; under stirring, the temperature was raised to 70° C. and the polymerization reaction was carried out at 70° C. for 1 hour, followed by cooling and stopping stirring, and the remaining propylene monomer was removed to obtain a polymer.

The catalyst prepared in Examples and Comparative Examples were evaluated in titanium content, and activity, and the prepared polymers were evaluated in isotacticity index (II), melt flow rate (MFR), bulk density (BD), and content of fine powder. The results were shown in Table 1 below.

TABLE 1

| | | | | | | Polymer fine |
|---|---|---|---|---|---|---|
| | Titanium | | | | | powder |
| | content | Activity | II | MFR | BD | <125 μm |
| | (%) | (Kg · PP/g · cat) | (%) | (g/10 min) | (g/cm³) | (%) |
| Example 1 | 3.9 | 39.2 | 98.1 | 29 | 0.43 | 0.2 |
| Example 2 | 4.5 | 37.4 | 97.9 | 30 | 0.43 | 0.2 |
| Example 3 | 3.6 | 36.8 | 97.5 | 27 | 0.42 | 0.2 |
| Example 4 | 3.8 | 40.1 | 98.0 | 29 | 0.43 | 0.2 |
| Example 5 | 4.2 | 38.7 | 96.7 | 32 | 0.41 | 0.3 |
| Example 6 | 4.0 | 37.1 | 96.1 | 31 | 0.41 | 0.3 |
| Example 7 | 4.1 | 30.6 | 95.8 | 36 | 0.39 | 0.5 |
| Example 8 | 4.3 | 35.5 | 95.1 | 34 | 0.39 | 0.6 |
| Example 9 | 4.2 | 36.0 | 95.3 | 35 | 0.40 | 0.6 |
| Comparative | 3.6 | 37.6 | 96.6 | 22 | 0.41 | 0.3 |
| Example 1 | | | | | | |
| Comparative | 3.7 | 38.1 | 96.4 | 23 | 0.41 | 0.3 |
| Example 2 | | | | | | |
| Comparative | 3.9 | 38.5 | 96.2 | 35 | 0.40 | 0.4 |
| Example 3 | | | | | | |

From the comparison of data in Table 1, it can be seen that the olefin polymerization catalyst of the present disclosure has a higher polymerization activity and a better stereospecificity, and the resultant polymer has a higher bulk density and less fine powder.

1. An olefin polymerization catalyst comprising a reaction product of:
a magnesium dialkoxide, a titanium compound, an electron donor compound A and an electron donor compound B;
wherein the electron donor compound A is a sulfonyl compound represented by general formula I: 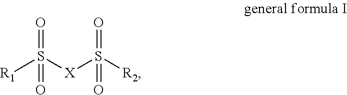
wherein X is selected from a group consisting of a disubstituted or unsubstituted group 14 element atom, a monosubstituted or unsubstituted group 15 element atom, and group 16 element atom, where the substituent is selected from a group consisting of a monocyclic, polycyclic or heteroatom-containing cyclic group and an aliphatic chain group; R₁ and R₂ are the same or different, and are respectively selected from a group consisting of hydrogen atom, halogen atom, substituted or unsubstituted alkyl, cycloalkyl, aryl, aralkyl, alkylaryl and heteroatom-containing cyclic group;
the electron donor compound B is selected from a group consisting of an ester compound and an ether compound;
the titanium compound has a general formula of Ti(OQ)₄₋ₙYₙ, where Q is selected from a group consisting of C₁-C₁₄ aliphatic hydrocarbyl and aromatic hydrocarbyl, Y is a halogen atom, n is an integer of 0 to 4; wherein when n is 2 or less, Q is the same or different;
the electron donor compound A is used in an amount of 0.01 to 1 mole with respect to 1 mole of magnesium in the magnesium dialkoxide;
the electron donor compound B is used in an amount of 0.01 to 1 mole with respect to 1 mole of magnesium in the magnesium dialkoxide; and
the titanium compound is used in an amount of 0.5 to 100 mole(s) with respect to 1 mole of magnesium in the magnesium dialkoxide.

2. The olefin polymerization catalyst according to claim 1, wherein the electron donor compound A is used in an amount of 0.05 to 0.2 mole with respect to 1 mole of magnesium in the magnesium dialkoxide.

3. The olefin polymerization catalyst according to claim 1, wherein the electron donor compound B is used in an amount of 0.05 to 0.2 mole with respect to 1 mole of magnesium in the magnesium dialkoxide.

4. The olefin polymerization catalyst according to claim 1, wherein the titanium compound is used in an amount of 1 to 50 mole(s) with respect to 1 mole of magnesium in the magnesium dialkoxide.

5. The olefin polymerization catalyst according to claim 1, wherein X is selected from a group consisting of C(R₃)(R₄), Si(R₃′)(R₄′), Sn(R₃″)(R₄″), Pb(R₃′″)(R₄′″), N(R₅), P(R₆), As(R₆′), O, S, Se and Te; wherein R₃ and R₄ are the same or different, R₃′ and R₄′ are the same or different, R₃″ and R₄″ are the same or different, R₃′″ and R₄′″ are the same or different, R₃, R₄, R₃′, R₄′, R₃″, R₄″, R₃′″, R₄′″, R₅, R₆ and R₆′ are respectively selected from a group consisting of hydrogen atom, halogen atom, substituted or unsubstituted alkyl, cycloalkyl, aryl, aralkyl, alkylaryl, alkylalkenyl, alkenylalkyl, alkylalkynyl, heteroatom-containing cyclic group and acyl.

6. The olefin polymerization catalyst according to claim 1, wherein the electron donor compound A is selected from a group consisting of disulfonyl alkane, disulfonyl olefin, disulfonyl cyclic hydrocarbon, disulfonyl silane, disulfonyl cyclosilane, disulfonyl dihydrocarbyl tin, disulfonyl dihydrocarbyl lead, and derivatives thereof with or without heteroatom; disulfonyl imine, disulfonyl phosphorous, disulfonyl arsenous, and derivatives thereof with or without heteroatom; substituted or unsubstituted sulfonic anhydride, and S-substituted or Se-substituted derivatives thereof.

7. The olefin polymerization catalyst according to claim 1, wherein the electron donor compound A is selected from a group consisting of bis(trifluoromethylsulfonyl)-methane; [bis(trifluoromethylsulfonyl)methyl]-benzene; 1,1-bis(trifluoromethylsulfonyl)-ethane; [chloro-(trifluoromethylsulfonyl)-methylsulfonyl]-trifluoro-methane; [bromo-(trifluoromethylsulfonyl)-methylsulfonyl]-trifluoro-methane; dichloro-bis-trifluoromethylsulfonyl-methane; dibromo-bis-trifluoromethylsulfonyl-methane; chloro-bromo-bis-trifluoromethylsulfonyl-methane; 2-[2,2-bis-(trifluoromethylsulfon yl)-vinyl]-1H-pyrrole; 4-[2,2-bis-(trifluoromethylsulfonyl)vinyl]-morpholine; 2-[2,2-bis-(trifluoromethylsulfonyl)-vinyl]-1H-indole; trifluoro-[methoxy-(trifluoromethylsulfonyl)-methylsulfonyl]-methane; 1-chloro-1,1-bis(trifluoromethylsulfonyl)-ethane; 1-bromo-1,1-bis(trifluoromethylsulfonyl)-ethane; 4,4-bis-(trifluoromethylsulfonyl)-but-1-ene; 1,3-bis-(trifluoromethylsulfonyl)-propan-1-ol; 1,1-bis-(trifluoromethylsulfonyl)-pentane; 4-bromo-4,4-bis-(trifluoromethylsulfonyl)-but-1-ene; 3-bromo-5-chloro-1,1-bis-(trifluoromethylsulfonyl)-pentane; 3-brom o-1,1-bis-(trifluoromethylsulfonyl)-nonane; [2,2-bis-(trifluoromethylsulfonyl)-ethyl]-benzene; 3-bromo-5,5-bis-(trifluoromethylsulfonyl)-pentanoic acid; 1,1-bis-(trifluoromethylsulfonyl)-propene; 2,2-bis-(trifluoromethylsulfonyl)-vin ylamine; [2,2-bis-(trifluoromethylsulfonyl)-vinyl]-dimethyl-amine; [3,3-bis-(trifluoro methylsulfonyl)-allyl]-benzene; 1-[2,2-bis-(trifluoromethylsulfonyl)-vinyl]-naphthalene; 4-[2,2-bis-(trifluoromethylylsulfonyl)-vinyl]-2-ethoxy-phenol; 1-[2,2-bis-(trifluoromethylsulfonyl)-vinyl]-4-nitro-benzene; (2,2-bis-trifluoromethanesulfonyl-vinyl)-benzene; 7,7-bis-(trifluoromethylsulfonyl)-bicyclo[4,1,0]-heptane; 1-[bis-(trifluoromethylsulfonyl)-methyl]-4-methyl-benzene; bis-(trifluoromethylsulfonyl)-ethenone; 1-[bis-(trifluoromethylsulfonyl)-methylene]-pyrimidine; [bis-(trifluoromethylsulfonyl)-methylene]-triphenyl-λ5-phosphorus; 1-[bis-(trifluoromethylsulfonyl)-methyl]-4-fluoro-benzene; difluoro-bis-trifluoromethylsulfonyl-methane; ethyl 3,2-bis-trifluoromethylsulfonyl-cyclopropane carboxylate; trifluoro-(fluoro-trifluoromethylsulfonyl-sulfonylmethyl)-methane; 1-(bis-trifluoromethylsulfonyl-methyl)-2,3,4,5,6-pentafluorobenzene; {4-[2,2-bis-(trifluoromethylsulfon yl)-vinyl]-phenyl}-diethyl-amine; {4-[4,4-bis-(trifluoromethylsulfonyl)-butyl-1,3-diethyl]-phenyl}-dimethyl-amine; 2-[2,2-bis-(trifluoromethylsulfonyl)-ethyl]-malonic acid; ethyl 2-[2,2-bis-(trifluoromethylsulfonyl)-ethyl]-3-oxo-butyrate; diethyl 2-[2,2-bis-(trifluoromethylsulfonyl)-ethyl]-2-bromo-malonate; 1,1,3,3-tetrakis-(trifluoromethylsulfonyl)-propane; 1,1,2,2-tetrakis-(trifluoromethylsulfonyl)-ethane; trifluoro-[methoxy-(trifluoromethylsulfonyl)-methanesulfonyl]-methane; [bis-(trifluoromethylsulfonyl)-methanesulfonyl]-trifluoro-methane; bis-(trifluoromethylsulfonyl)-ethenone; ethyl 1,2-di-(trifluoromethylsulfonyl)-malonate; [(dimethyl-λ4-sulfonamidenyl)-trifluoromethylsulfonyl-mesyl]-trifluoro-methane; 1-diethyl-sulfonamide-2,2-bis(trifluoromethylsulfonyl)-ethylene; 1-[bis-(trifluoromethylsulfonyl)-methyl]-4-iodo-benzene; 1-[bis-(trifluoromethylsulfonyl)-methyl]-4-fluoro-benzene; N-[bis-(trifluoromethylsulfonyl)-methylene]-N′-(4-nitro-phenyl)-hydrazine; 2,2-bis(isopropylamine)-1,1-(trifluoromethylsulfonyl)-ethylene; 1-(2,2-bis-trifluoromethylsulfonyl-cyclopropyl)-ethanone; 1-(2,2-trifluoromethanesulfonyl-vinyl)-4-methyl-benzene; dimethyl(1-p-tolyl-2,2-bis-trifluoromethanesulfonyl-ethyl)-phosphate; 1-(bis-trifluoromethylsulfonyl-methylsulfonyl)-4-chloro-benzene; (1-methyl-2,2-bis-trifluoromethyl sulfonyl-vinyl)-phenyl-amine; 1-(bis-trifluoromethylsulfonyl-methyl)-4-tetra-butyl-2,3,5,6-tetrafluoro-benzene; 1-(bis-trifluoromethylsulfonyl-methyl)-4-tetra-butyl-2,3,5,6-tetrafluoro-biphenyl; trimethyl-(pentafluorophenyl-bis-trifluoromethylsulfonyl-methyl)-silane; fluoro-tris-trifluoromethylsulfonyl-methane; 1-(bis-trifluoromethylsulfonyl-methyl)-2,3,5,6-tetrafluoro-4-hexyloxy-benzene; N-phenyl-bis(trifluoromethylsulfonyl)amine; N-2,6-diisopropylphenyl-bis(trifluoromethylsulfonyl)amine; N-(4-methoxyphenyl)-bis(trifluoromethylsulfonyl)amine; N-(3-chlorophenyl)-bis(trifluoromethylsulfonyl)amine; N-(2-fluorophenyl)-bis(trifluoromethylsulfonyl)amine; N-isobutyl-bis(trifluoromethylsulfonyl)amine; N-(2-methoxyethyl)-bis(trifluoromethylsulfonyl)amine; N-ethyl-bis(trifluoromethylsulfonyl)amine; N-benzyl-bis(trifluoromethylsulfonyl)amine; N-n-hexyl-bis(trifluoromethylsulfonyl)amine; N-(2-phenylethyl)-bis(trifluoromethylsulfonyl)amine; N-thienyl-bis(trifluoromethylsulfonyl)amine; N-cyclohexyl-bis(trifluoromethylsulfonyl)amine; N-(4-fluorophenyl)-bis(trifluoromethylsulfonyl)amine; N-(3-methylphenyl)-bis(trifluoromethylsulfonyl)amine; N-(4-methylphenyl)-bis(trifluoromethylsulfonyl)amine; N-(4-carboxyphenyl)-bis(trifluoromethylsulfonyl)amine; N-(3-carboxyphenyl)-bis(trifluoromethylsulfonyl)amine; bis(trifluoromethylsulfonyl)amine; N-fluoro-bis(trifluoromethylsulfonyl)amine; N-(2-pyridinyl)-bis(tri fluoromethylsulfonyl)amine; N-(5-chloro-2-pyridinyl)-bis(trifluoromethylsulfonyl)amine; N-(trimethylsilyl)-bis(trifluoromethylsulfonyl)amine; N-isopropyl-bis(tri fluoromethylsulfonyl)amine; phosphine-phenyl-bis(trifluoromethylsulfonyl)phosphorous; and trifluoromethanesulfonic anhydride.

8. The olefin polymerization catalyst according to claim 1, wherein the electron donor compound B is selected from a group consisting of a carboxylic acid ester compound and a diether compound.

9. The olefin polymerization catalyst according to claim 8, wherein the carboxylic acid ester compound includes monovalent or polyvalent aliphatic carboxylic acid ester or an aromatic carboxylic acid ester.

10. The olefin polymerization catalyst according to claim 8, wherein the carboxylic acid ester compound includes ethyl benzoate, diethyl phthalate, di-n-butyl phthalate, diisobutyl phthalate, di-n-octyl phthalate, diisooctyl phthalate, diethyl malonate, dibutyl malonate, diethyl 2,3-diisopropylsuccinate, di-n-butyl 2,3-diisopropylsuccinate, diisobutyl 2,3-diisopropylsuccinate, dimethyl 2,3-diisopropylsuccinate, diisobutyl 2,2-dimethylsuccinate, diisobutyl 2-ethyl-2-methylsuccinate, diethyl 2-ethyl-2-methyl succinate, diethyl adipate, dibutyl adipate, diethyl sebacate, dibutyl sebacate, diethyl maleate, di-n-butyl maleate, diethyl naphthalenedicarboxylate, dibutyl naphthalenedicarboxylate, triethyl trimellitate, tributyl trimellitate, tributyl hemimellitate, triethyl hemimellitate, tetraethyl pyromellitate or tetrabutyl pyromellitate.

11. The olefin polymerization catalyst according to claim 8, wherein the diether compound includes a 1,3-diether compound.

12. The olefin polymerization catalyst according to claim 1, produced by using the magnesium dialkoxide as a support and an inert solvent as a dispersant, contacting the magnesium dialkoxide and the inert solvent with the titanium compound to form a first mixture, then contacting the first mixture with the electron donor compound A and the electron donor compound B to form a second mixture, and contacting the second mixture with the titanium compound.

13. The olefin polymerization catalyst according to claim 12, wherein the inert solvent is selected from a group consisting of hexane, heptane, octane, decane, benzene, toluene and xylene, and is used in an amount of 0.5 to 100 mole(s) with respect to 1 mole of magnesium in the magnesium dialkoxide.

14. A combined catalyst for olefin polymerization, comprising:
component (1): a olefin polymerization catalyst according to claim 1;
component (2): an organoaluminum compound having a general formula of AlTₘZ₃₋ₘ, where T is selected from a group consisting of hydrogen, and C₁-C₂₀ hydrocarbyl, Z is halogen atom, and m is an integer of no greater than 3;
wherein the ratio of the component (1) to the component (2) is 10 to 1000 in terms of the molar ratio of aluminum to titanium.

15. The combined catalyst according to claim 14, further comprising component (3): an organosilicon compound having a general formula of L₁L₂Si(OL′)₂, where L₁ and L₂ are the same or different, and are respectively selected from a group consisting of C₁-C₂₀ alkyl, C₃-C₂₀ cycloalkyl and C₃-C₂₀ aryl, L′ is C₁-C₄ alkyl; wherein the ratio of the component (2) to the component (3) is 4 to 40 in terms of the molar ratio of aluminum to silicon.
